(19) United States
(12) Patent Application Publication
(10) Pub. No.: US 2024/0382849 A1
(43) Pub. Date: Nov. 21, 2024

(54) VIRTUAL CHARACTER DISPLAY METHOD AND APPARATUS, STORAGE MEDIUM, AND ELECTRONIC DEVICE

(71) Applicant: Tencent Technology (Shenzhen) Company Limited, Shenzhen (CN)

(72) Inventor: Zhihong LIU, Shenzhen (CN)

(73) Assignee: Tencent Technology (Shenzhen) Company Limited, Shenzhen (CN)

(21) Appl. No.: 18/786,155

(22) Filed: Jul. 26, 2024

Related U.S. Application Data
(63) Continuation of application No. PCT/CN2023/117525, filed on Sep. 7, 2023.

(30) Foreign Application Priority Data
Sep. 30, 2022 (CN) 202211215692.2

(51) Int. Cl. A63F 13/5372; A63F 13/52; A63F 13/58; A63F 13/822; A63F 13/837; A63F 13/87

(52) U.S. Cl. CPC A63F 13/5372; A63F 13/52; A63F 13/58; A63F 13/87; A63F 13/822; A63F 13/837

(57) ABSTRACT

In a virtual character display method, a game scene of a first virtual character in a game application is displayed. A target marker is displayed based on an attack event between the first virtual character and a second virtual character being generated in the game application. The target marker is configured to mark the second virtual character in the game scene when the attack event is generated. The target marker moves in accordance with movement of the second virtual character.

### RELATED APPLICATIONS

The present application is a continuation of International Application No. PCT/CN2023/117525, filed on Sep. 7, 2023, which claims priority to Chinese Patent Application No. 202211215692.2, filed on Sep. 30, 2022 and entitled “VIRTUAL CHARACTER DISPLAY METHOD AND APPARATUS, STORAGE MEDIUM, AND ELECTRONIC DEVICE.” The entire disclosures of the prior applications are hereby incorporated by reference.

### FIELD OF THE TECHNOLOGY

This application relates to the field of computers, including to a virtual character display method and apparatus, a storage medium, and an electronic device.

### BACKGROUND OF THE DISCLOSURE

Currently, when a user controls a virtual character to play with virtual characters in different camps, there are generally various virtual characters in different camps, and a game tempo is fast. As a result, when the user is attacked, there is a high probability that the origin of the attack cannot be determined; and when the user intends to counteract after being attacked, it is difficult to quickly identify a virtual character actually launching the attack due to various virtual characters in other camps, resulting in low efficiency of displaying the virtual character.

For the foregoing problem, no effective solution has been provided yet.

### SUMMARY

Aspects of this disclosure provide a virtual character display method and apparatus, a non-transitory computer-readable storage medium, and an electronic device, to address at least a technical problem of low efficiency of displaying a virtual character in the related art.

According to an aspect of this disclosure, a virtual character display method is provided. In the virtual character display method, a game scene of a first virtual character in a game application is displayed. A target marker is displayed based on an attack event between the first virtual character and a second virtual character being generated in the game application. The target marker is configured to mark the second virtual character in the game scene when the attack event is generated. The target marker moves in accordance with movement of the second virtual character.

According to another aspect of this disclosure, an information processing apparatus, such as a virtual character display apparatus, is further provided. The information processing apparatus includes processing circuitry that is configured to display a game scene of a first virtual character in a game application. The processing circuitry is configured to display a target marker based on an attack event between the first virtual character and a second virtual character being generated in the game application. The target marker is configured to mark the second virtual character in the game scene when the attack event is generated. The processing circuitry is configured to move the target marker in accordance with movement of the second virtual character.

According to still another aspect of this disclosure, a non-transitory computer-readable storage medium is further provided, the non-transitory computer-readable storage medium storing instructions which when executed by a processor cause the processor to perform the foregoing virtual character display method.

According to still another aspect of this disclosure, a computer program product or a computer program is provided, the computer program product or the computer program including computer instructions, the computer instructions being stored in a computer-readable storage medium. A processor of a computer device reads the computer instructions from the computer-readable storage medium, and executes the computer instructions, to cause the computer device to perform the foregoing virtual character display method.

According to still another aspect of this disclosure, an electronic device is further provided, including a memory and a processor, the memory having a computer program stored therein, and the processor being configured to perform the foregoing virtual character display method through the computer program.

In an aspect of this disclosure, a target outline marker is displayed in a target application when an attack event is generated and a second virtual character is within a field of view range of a first virtual character, the target outline marker being an outline marker newly added for the second virtual character, and the target outline marker being configured for marking the second virtual character in the first picture when the attack event is generated; and the target outline marker is moved to a location corresponding to the second virtual character when the second virtual character moves. When the attack event is generated, for example, when the first virtual character attacks the second virtual character, or the first virtual character is attacked by the second virtual character, or the first virtual character attacks the second virtual character and is also attacked by the second virtual character, the target outline marker configured for indicating that the attack event is generated between the first virtual character and the second virtual character is displayed in the target application. In this way, the second virtual character in the attack event is quickly marked in the picture, and efficiency of displaying the virtual character is improved, thereby improving a perception ability and perception efficiency of a user for the location of the second virtual character in the attack event, and improving use experience.

### BRIEF DESCRIPTION OF THE DRAWINGS

FIG. 1 is a schematic diagram of an application environment of an virtual character display method according to an embodiment of this disclosure.

FIG. 2 is a schematic flowchart of an virtual character display method according to an embodiment of this disclosure.

FIG. 3 is a schematic diagram of an virtual character display method according to an embodiment of this disclosure.

FIG. 4 is a schematic diagram of another virtual character display method according to an embodiment of this disclosure.

FIG. 5 is a schematic diagram of still another virtual character display method according to an embodiment of this disclosure.

FIG. 6 is a schematic diagram of still another virtual character display method according to an embodiment of this disclosure.

FIG. 7 is a schematic diagram of still another virtual character display method according to an embodiment of this disclosure.

FIG. 8 is a schematic diagram of still another virtual character display method according to an embodiment of this disclosure.

FIG. 9 is a schematic diagram of still another virtual character display method according to an embodiment of this disclosure.

FIG. 10 is a schematic diagram of still another virtual character display method according to an embodiment of this disclosure.

FIG. 11 is a schematic diagram of still another virtual character display method according to an embodiment of this disclosure.

FIG. 12 is a schematic diagram of still another virtual character display method according to an embodiment of this disclosure.

FIG. 13 is a schematic diagram of still another virtual character display method according to an embodiment of this disclosure.

FIG. 14 is a schematic diagram of still another virtual character display method according to an embodiment of this disclosure.

FIG. 15 is a schematic diagram of still another virtual character display method according to an embodiment of this disclosure.

FIG. 16 is a schematic diagram of still another virtual character display method according to an embodiment of this disclosure.

FIG. 17 is a schematic diagram of still another virtual character display method according to an embodiment of this disclosure.

FIG. 18 is a schematic diagram of still another virtual character display method according to an embodiment of this disclosure.

FIG. 19 is a schematic diagram of still another virtual character display method according to an embodiment of this disclosure.

FIG. 20 is a schematic structural diagram of an virtual character display apparatus according to an embodiment of this disclosure.

FIG. 21 is a schematic structural diagram of an virtual character display product according to an embodiment of this disclosure.

FIG. 22 is a schematic structural diagram of an electronic device according to an embodiment of this disclosure.

### DESCRIPTION OF EMBODIMENTS

To aid a person skilled in the art to better understand solutions of this disclosure, the following describes examples of the technical solutions in the embodiments of this disclosure with reference to the accompanying drawings. The described embodiments are merely a part rather than all of the embodiments of this disclosure. Other embodiments obtained by a person skilled in the art based on the embodiments of this disclosure shall fall within the protection scope of this disclosure.

In the specification, claims, and accompanying drawings of this disclosure, the terms “first”, “second”, and the like are intended to distinguish between similar objects but do not necessarily indicate a specific order or sequence. The data termed in such a way is interchangeable in proper circumstances, so that the embodiments of this disclosure described herein can be implemented in other orders than the order illustrated or described herein. In addition, the terms “include” and “have” and any other variants are intended to cover the non-exclusive inclusion. For example, a process, method, system, product, or device that includes a list of operations or units is not necessarily limited to those expressly listed operations or units, but may include other operations or units not expressly listed or inherent to such a process, method, product, or device.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

First, examples of some terms appearing in the process of describing the embodiments of this disclosure are provided. The descriptions of the terms are provided as examples only and are not intended to limit the scope of the disclosure.

A shooting game is, for example, a game that uses hot weapons for long-range attack, including, but not limited to, a first-person shooting game (FPS) and a third-person shooting game (TPS).

The first-person shooting game is, for example, a branch of action games (ACT). As the name implies, the first-person shooting game is a shooting game from a subjective perspective of a player.

The third-person shooting game is also a type of shooting game. Different from that of the first-person shooting game, a player is visible on a game screen in the third-person shooting game.

This disclosure is described below with reference to the embodiments.

According to an aspect of the embodiments of this disclosure, a virtual character display method is further provided. In this embodiment, the foregoing virtual character display method may be applied to a hardware environment including a server 101 and a terminal device 103 shown in FIG. 1. As shown in FIG. 1, the server 101 is connected to a terminal 103 through a network, and may be configured to provide services for a terminal device or an application program installed on the terminal device. The application program may be a video application program, an instant messaging application program, a browser application program, an education application program, a game application program, or the like. A database 105 may be arranged on or independent of the server, to provide a data storage service for the server 101, for example, a game data storage server. The foregoing network may include, but is not limited to, a wired network and a wireless network. The wired network includes a local area network, a metropolitan area network, and a wide area network. The wireless network includes Bluetooth, WIFI, and other networks that implement wireless communication. The terminal device 103 may be a terminal configured with an application program, and may include, but is not limited to, at least one of the following: a mobile phone (such as an Android mobile phone or an IOS mobile phone), a notebook computer, a tablet computer, a palmtop computer, a mobile Internet device (MID), a PAD, a desktop computer, a smart television, or another computer device. The foregoing server may be a single server, or a server cluster including a plurality of servers, or a cloud server.

As shown in FIG. 1, the foregoing virtual character display method may be implemented in the terminal device 103 through the following operations.

S1: Display a first picture in a target application of the terminal device 103, the first picture including a first virtual character. In an example, a game scene of a first virtual character in a game application is displayed.

S2: Display a target outline marker in the target application of the terminal device 103 when an attack event is generated and a second virtual character is within a field of view range of the first virtual character, the target outline marker being an outline marker newly added for the second virtual character, the target outline marker being configured for marking the second virtual character in the first picture when the attack event is generated, and the attack event including any one of that the first virtual character attacks the second virtual character, that the first virtual character is attacked by the second virtual character, or that the first virtual character attacks the second virtual character and is also attacked by the second virtual character. In an example, a target marker is displayed based on an attack event between the first virtual character and a second virtual character being generated in the game application. The target marker is configured to mark the second virtual character in the game scene when the attack event is generated.

S3: Move, on the terminal device 103, the target outline marker to a location corresponding to the second virtual character when the second virtual character moves. In an example, the target marker moves in accordance with movement of the second virtual character.

In this embodiment, the foregoing virtual character display method may alternatively be implemented by a server, for example, implemented by the server 101 shown in FIG. 1; or may be implemented by a user terminal and a server jointly.

The foregoing is merely an example. This is not limited in the embodiments.

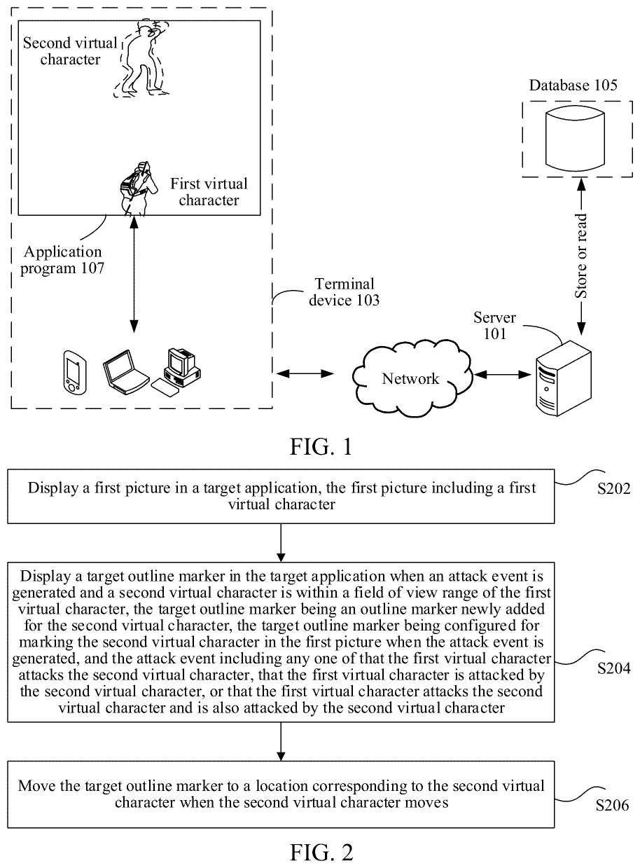

In an implementation, as shown in FIG. 2, the foregoing virtual character display method includes the following operations.

S202: Display a first picture in a target application, the first picture including a first virtual character.

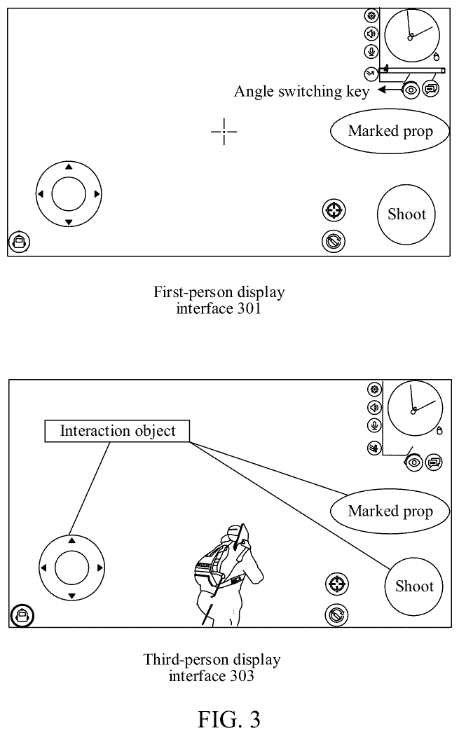

In the embodiments of this disclosure, the foregoing virtual character display method may be applied to various applications, but is not limited thereto. By using an example in which the target application is a target game application, the foregoing target game application may be a multiplayer online battle arena (MOBA) game or a single-player game (SPG), and is not specifically limited herein. The foregoing target game application may include, but is not limited to, a shooting application, a role-playing application, an instant strategy application, and the like. The foregoing shooting application may include, but is not limited to, a first-person shooting application, a third-person shooting application, and a shooting application that can switch between a first person and a third person. FIG. 3 is a schematic diagram of a virtual character display method according to an embodiment of the present disclosure. As shown in FIG. 3, an application display interface may be distinguished into a first-person display interface 301 and a third-person display interface 303, and includes, but is not limited to, a display interface for performing switching between the first person and the third person by using a perspective-switching interaction key. An interaction operation is performed on an interaction object “marked prop”, to allow the foregoing virtual character display method to be used.

The foregoing target application may include, but is not limited to, at least one of the following: a two-dimensional (2D) game application, a three-dimensional (3D) game application, a virtual reality (VR) game application, an augmented reality (AR) game application, or a mixed reality (MR) game application. The foregoing is merely an example. This is not limited in the embodiments.

For example, in the current related art, when the first virtual character is attacked by another virtual character, generally, only a direction indicator is displayed to indicate a source direction of the attack, and a user can only learn the direction of the attack by an enemy. However, when there are many masks or other virtual characters in the direction, the user cannot identify which virtual character the attack is specifically from. In this embodiment, when the first virtual character controlled by the user is attacked by the second virtual character, the target outline marker configured for indicating that the attack to the first virtual character is from the second virtual character is displayed, so that the objective of quickly marking the virtual character launching the attack to the user in the first picture is achieved, thereby achieving the technical effect of improving efficiency of displaying the virtual character.

In this embodiment, the foregoing first picture may include, but is not limited to, a first picture obtained by rendering, by the terminal device, data according to the data related to the target application delivered by the server; or may include, but is not limited to, a first picture obtained by rendering, by the terminal device, data according to the data locally stored by the target application in the terminal device.

In this embodiment, the foregoing first virtual character includes, but is not limited to, a virtual operation object that is in a game having been started and that is controlled by the user that logs in to the foregoing target application through a participation account.

In this embodiment, the foregoing second virtual character includes, but is not limited to, a virtual operation object that is in a different camp than the first virtual character and that is controlled by another user through a participation account in the foregoing target application; or may include, but is not limited to, a virtual operation object that is in a different camp than the first virtual character and that is preset by a system generated by the server.

S204: Display a target outline marker in the target application when an attack event is generated and a second virtual character is within a field of view range of the first virtual character, the target outline marker being an outline marker newly added for the second virtual character, the target outline marker being configured for marking the second virtual character in the first picture when the attack event is generated, and the attack event including any one of that the first virtual character attacks the second virtual character, that the first virtual character is attacked by the second virtual character, or that the first virtual character attacks the second virtual character and is also attacked by the second virtual character.

In this embodiment, the foregoing attack event may include, but is not limited to, that the first virtual character attacks the second virtual character, or that the first virtual character is attacked by the second virtual character, or that the first virtual character attacks the second virtual character and is also attacked the second virtual character. For example, that the first virtual character is attacked by the second virtual character may include, but is not limited to, that the second virtual character launches an attack operation to the first virtual character by using a game operation such as a virtual attack prop, a virtual skill, or a virtual action. The attack operation may include, but is not limited to, reducing a virtual hit point of the first virtual character or reducing a virtual armor value of the first virtual character. In other words, when a character parameter of the first virtual character changes due to the game operation performed by the second virtual character, the foregoing first virtual character is attacked by the second virtual character, and vice versa.

In this embodiment, that the foregoing second virtual character is within the field of view range of the first virtual character may be understood as that a location of the foregoing second virtual character in a game scene is located inside a current field of view of the first virtual character, and specifically, may include, but is not limited to, that the second virtual character may be observed in a first picture of the first virtual character.

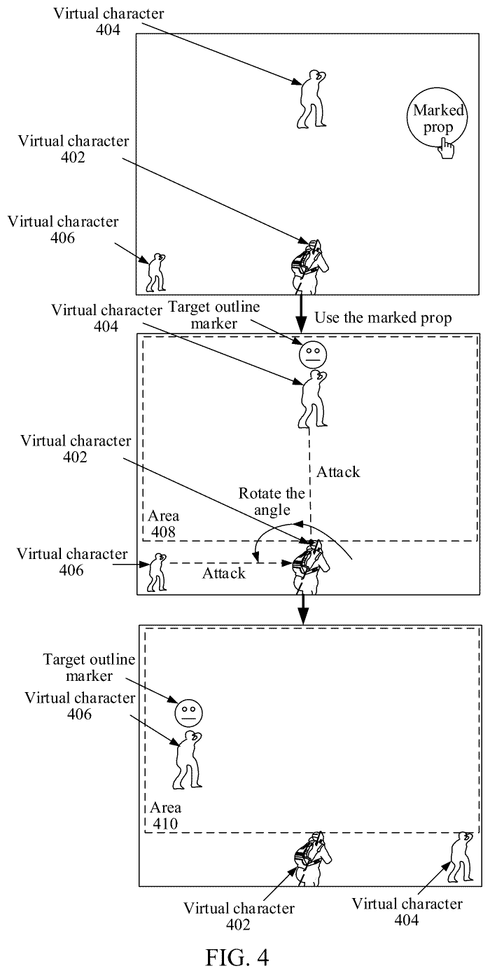

In an embodiment, FIG. 4 is a schematic diagram of another virtual character display method according to an embodiment of the present disclosure. As shown in FIG. 4, a virtual character 402, a virtual character 404, and a virtual character 406 are included. The virtual character 402 corresponds to the foregoing first virtual character, and both the virtual character 404 and the virtual character 406 are virtual characters that are in a different camp than the virtual character 402 and that attack the virtual character 402. A field of view range of the virtual character 402 includes an area 408, the virtual character 404 is located inside the area 408, and the virtual character 406 is outside the area 408. In this case, the foregoing virtual character 404 is the foregoing second virtual character, and the foregoing virtual character 406 is not the foregoing second virtual character.

The foregoing field of view range of the virtual character 402 is adjustable, and specifically, may include, but is not limited to, being implemented by touching a screen, moving a mouse, or the like. When the field of view range of the virtual character 402 is adjusted to an area 410, the foregoing virtual character 404 is outside the area 410, and the virtual character 406 is located inside the area 410. In this case, the virtual character 406 is the foregoing second virtual character, and the foregoing virtual character 404 is not the foregoing second virtual character. In other words, if a virtual character launches an attack to the first virtual character and is also within the field of view range of the first virtual character, the virtual character is the second virtual character. In this case, the foregoing target outline marker may be displayed to mark the foregoing second virtual character.

S206: Move the target outline marker to a location corresponding to the second virtual character when the second virtual character moves.

In this embodiment, the foregoing second virtual character is a virtual character allowed to move. When the second virtual character moves, the target outline marker may move following the second virtual character. Certainly, when the second virtual character does not move, the foregoing target outline marker that does not move may also be continuously displayed.

The foregoing target outline marker may be further configured as follows: The displaying of the foregoing target outline marker is canceled when the second virtual character moves, or the displaying of the foregoing target outline marker is canceled when the first virtual character moves, or the displaying of the foregoing target outline marker is canceled when the target outline marker has been displayed for preset duration.

Through this embodiment, a target outline marker is displayed in a target application when an attack event is generated and a second virtual character is within a field of view range of a first virtual character, the target outline marker being an outline marker newly added for the second virtual character, and the target outline marker being configured for marking the second virtual character in the first picture when the attack event is generated; and the target outline marker is moved to a location corresponding to the second virtual character when the second virtual character moves. When the attack event is generated, for example, when the first virtual character attacks the second virtual character, or the first virtual character is attacked by the second virtual character, or the first virtual character attacks the second virtual character and is also attacked by the second virtual character, the target outline marker configured for indicating that the attack event is generated between the first virtual character and the second virtual character is displayed in the target application. In this way, the second virtual character in the attack event is quickly marked in the picture, and efficiency of displaying the virtual character is improved, thereby improving a perception ability and perception efficiency of a user for the location of the second virtual character in the attack event, and improving usc experience.

In a solution, the displaying a target outline marker in the target application when an attack event is generated and a second virtual character is within a field of view range of the first virtual character may specifically include: displaying the target outline marker in the target application when the attack event is that the first virtual character is attacked by the second virtual character, the target outline marker being configured for indicating that the attack to the first virtual character is from the second virtual character.

In this embodiment, the foregoing target outline marker may include, but is not limited to, being configured for indicating that the attack to the first virtual character is from the second virtual character, that is, marking the second virtual character launching the attack to the first virtual character in the first picture, so that the user quickly determines a source of the attack through a perspective of the first virtual character.

Specifically, the foregoing target outline marker may include, but is not limited to, a location marker, an outline marker, a color marker, or the like, to mark the second virtual character at the location of the second virtual character.

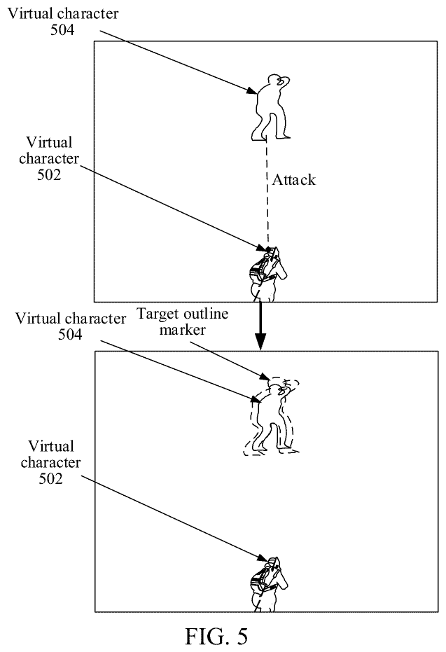

In an embodiment, FIG. 5 is a schematic diagram of still another virtual character display method according to an embodiment of the present disclosure. As shown in FIG. 5, a virtual character 502 and a virtual character 504 are included. The virtual character 502 corresponds to the foregoing first virtual character, and the virtual character 504 corresponds to the foregoing second virtual character. After the virtual character 504 launches an attack to the virtual character 502, the virtual character 504 is marked in a first picture of the virtual character 502 by using a target outline marker, so that a user controlling the virtual character 502 quickly identifies that the foregoing virtual character 504 is a virtual character launching the attack to the user. The foregoing virtual character 502 and the virtual character 504 are in different camps, and the virtual character 504 is within a field of view range of the virtual character 502.

Through this embodiment, when the first virtual character controlled by the user is attacked by the second virtual character, the target outline marker configured for indicating that the attack to the first virtual character is from the second virtual character is displayed, so that the objective of quickly marking the virtual character launching the attack to the user in the first picture is achieved, thereby improving efficiency of displaying the virtual character. In this way, the user can quickly determine a location of an enemy launching the attack to the user, thereby improving a perception ability and perception efficiency of the user for the location of the second virtual character in the attack event, and improving use experience.

In a solution, the foregoing method further includes at least one of the following: displaying a first prop marker in the first picture, the first prop marker being configured for marking, in the first picture, a virtual prop used by the second virtual character when the second virtual character attacks the first virtual character; or displaying a first camp marker in the first picture, the first camp marker being configured for marking, in the first picture, a camp of the second virtual character attacking the first virtual character. In this embodiment, the foregoing target outline marker may include, but is not limited to, an outline marker generated according to a character model of the foregoing second virtual character. The outline marker may be configured for marking the foregoing target outline marker in the first picture in a form of a line.

In this embodiment, the foregoing first prop marker may include, but is not limited to, being configured for marking the virtual prop used by the second virtual character when the second virtual character attacks the first virtual character, marking a virtual skill used by the second virtual character when the second virtual character attacks the first virtual character, or the like, so that the attacked user can quickly determine a prop used by an enemy attacking the user, and then quickly make a counterattack solution for the enemy, thereby increasing game interest, and improving operation efficiency of the user.

In this embodiment, the foregoing first camp marker may include, but is not limited to, being configured for marking the camp of the second virtual character when the second virtual character attacks the first virtual character. Three camps or more may simultaneously participate in the game established by the foregoing target application. In this case, when the virtual character controlled by the user is attacked, the user cannot learn that an enemy in which camp attacks the virtual character; and when second virtual characters in different camps have similar appearances, it is difficult for the user to selectively counterattack a second virtual character in a specific camp. Through the foregoing camp marker, the attacked user can distinguish to perform a selective counterattack, thereby increasing game interest, and improving operation efficiency of the user.

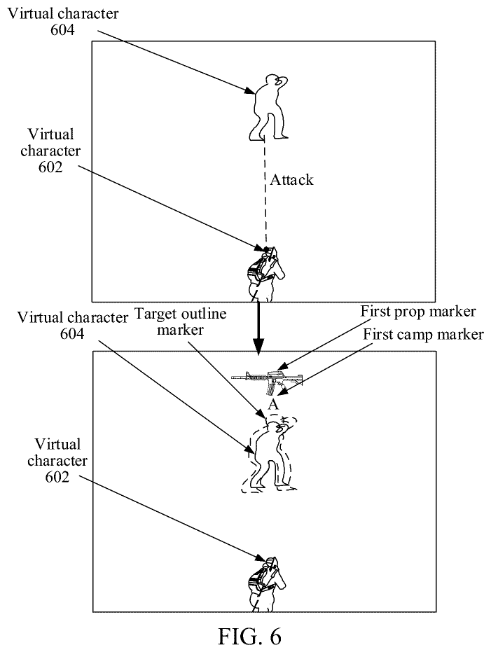

In an embodiment, FIG. 6 is a schematic diagram of still another virtual character display method according to an embodiment of the present disclosure. As shown in FIG. 6, a virtual character 602 and a virtual character 604 are included. The virtual character 602 corresponds to the foregoing first virtual character, and the virtual character 604 corresponds to the foregoing second virtual character. After the virtual character 604 launches an attack to the virtual character 602, the virtual character 604 is marked in a first picture of the virtual character 602 by using a target outline marker 606, and then the virtual character 604 is marked by using a first prop marker 608 or a first camp marker 610 according to a virtual prop used by the virtual character 604 or a camp of the virtual character, so that a user controlling the virtual character 602 quickly learns camp information, prop information, and the like related to an enemy, thereby improving game efficiency of the user, and enriching selection of the user.

In a solution, the displaying the target outline marker in the target application when the attack event is that the first virtual character is attacked by the second virtual character includes at least one of the following: displaying the target outline marker in the target application according to a virtual hit point of the first virtual character, a color of the target outline marker being determined according to a value of the virtual hit point of the first virtual character; displaying the target outline marker in the target application according to a virtual hit point of the first virtual character, clarity of the target outline marker being determined according to a value of the virtual hit point of the first virtual character; or displaying the target outline marker in the target application according to a quantity of attacks by the second virtual character to the first virtual character, clarity of the target outline marker being determined according to a value of the quantity of attacks.

In this embodiment, the foregoing virtual hit point may be flexibly set according to different target applications. The virtual hit point is configured for indicating whether the foregoing first virtual character is hit and defeated. When the virtual hit point of the first virtual character is partially deducted, the foregoing first virtual character is attacked. When the virtual hit point of the first virtual character is all deducted or reaches a preset threshold, the foregoing first virtual character is defeated.

In this embodiment, the foregoing target outline marker may be configured as an outline marker with a colored edge line, for example, a red marker or a green marker. Further, the color of the foregoing target outline marker may be correlated with a current value of the virtual hit point of the foregoing first virtual character, and the depth of the foregoing color may be set to be negatively correlated with the value of the foregoing virtual hit point. In other words, a smaller virtual hit point of the first virtual character indicates a darker color of the foregoing target outline marker. In this case, when a target outline marker with a darker color is observed, the user can determine that the user has a smaller virtual hit point, and needs to defeat the second virtual character with the target outline marker as soon as possible, to avoid being defeated by the second virtual character.

In this embodiment, the foregoing target outline marker may be configured as an outline marker filled with a pattern, for example, an outline marker filled with a preset color. The clarity of the foregoing target outline marker may be correlated with a current value of the virtual hit point of the foregoing first virtual character, and the level of the foregoing clarity may be set to be negatively correlated with the value of the foregoing virtual hit point. In other words, a smaller virtual hit point of the first virtual character indicates higher clarity of the foregoing target outline marker. In this case, when the user has a smaller virtual hit point, the user can observe a clearer target outline marker, and needs to defeat the second virtual character with the target outline marker as soon as possible, to avoid being defeated by the second virtual character.

In this embodiment, the foregoing target outline marker may be configured as an outline marker filled with a pattern, for example, an outline marker filled with a preset color. The clarity of the foregoing target outline marker may be correlated with the foregoing quantity of attacks by the second virtual character to the first virtual character, and the level of the foregoing clarity may be set to be positively correlated with the foregoing quantity of attacks. In other words, a greater quantity of attacks indicates higher clarity of the foregoing target outline marker, to avoid that the user still cannot observe the second virtual character when the target outline marker is displayed due to low clarity.

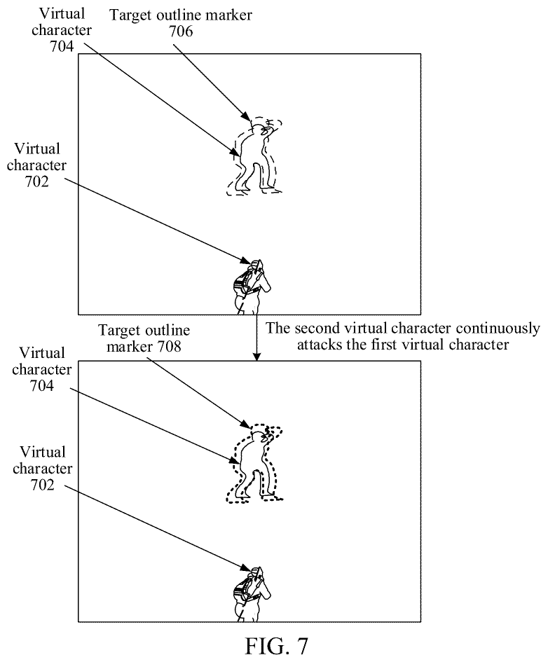

In an embodiment, FIG. 7 is a schematic diagram of still another virtual character display method according to an embodiment of the present disclosure. As shown in FIG. 7, a virtual character 702 and a virtual character 704 are included. The virtual character 702 corresponds to the foregoing first virtual character, and the virtual character 704 corresponds to the foregoing second virtual character. After the virtual character 704 launches an attack to the virtual character 702, the virtual character 704 is marked in a first picture of the virtual character 702 by using a target outline marker 706, and in this case, a virtual hit point of the virtual character 702 is 60. When the virtual character 704 continuously attacks the virtual character 702, the virtual hit point of the virtual character 702 is deducted from 60 to 20, and the virtual character 704 is marked in the first picture of the virtual character 702 by using a target outline marker 708. It can be learned from a thickness of a line in FIG. 7 that, a larger virtual hit point of the virtual character 702 indicates a darker color and higher clarity of the target outline marker, so that the user controlling the virtual character 702 quickly recognizes enemy outline information, thereby improving game efficiency of the user, and enriching selection of the user.

Through this embodiment, an outline of a virtual character launching an attack is displayed, to more clearly present the outline of the virtual character launching the attack in the first picture, so that the user can quickly learn a location of an enemy launching the attack to the user, thereby improving use experience, and improving efficiency of displaying the virtual character.

In a solution, the foregoing method further includes: displaying a plurality of target outline markers in a one-to-one correspondence with a plurality of second virtual characters in the target application when the first virtual character is attacked by the plurality of second virtual characters and the plurality of second virtual characters are all within the field of view range of the first virtual character; and canceling the displaying of the target outline marker corresponding to the target virtual character when the plurality of second virtual characters except the target virtual character move from within the field of view range of the first virtual character to outside the field of view range of the first virtual character.

In this embodiment, when the first virtual character is attacked by the plurality of second virtual characters within a preset time period, the plurality of target outline markers in a one-to-one correspondence with the plurality of second virtual characters may be displayed in the target application. In other words, the plurality of target outline markers may be configured to be allowed to simultaneously exist. An upper quantity limit may also be set, and when the upper quantity limit is not reached, the plurality of target outline markers may be simultaneously displayed. Alternatively, an upper quantity limit of target outline markers allowed to be simultaneously displayed within the preset time period may be set. The preset time period may include, but is not limited to, configuring the foregoing preset time period for each target outline marker. The time period is counted from a time point when the first virtual character is attacked by the second virtual character, and the displaying of the foregoing target outline marker is canceled when the foregoing preset time period is reached.

In this embodiment, that the foregoing plurality of second virtual characters except the target virtual character move from within the field of view range of the first virtual character to outside the field of view range of the first virtual character may be understood as that some or all of the plurality of second virtual characters are in a moving state after attacking the first virtual character. When only the target virtual character remains within the field of view range of the first virtual character, the displaying of the target outline marker corresponding to the foregoing target virtual character is canceled. Because only one second virtual character exists within the field of view range in this case, the first virtual character controlled by the user may not need to observe the foregoing target virtual character through the foregoing target outline marker. The displaying of the target outline marker related to the target virtual character is canceled, so that system rendering overheads and computing overheads can be reduced, thereby avoiding waste of computing resources.

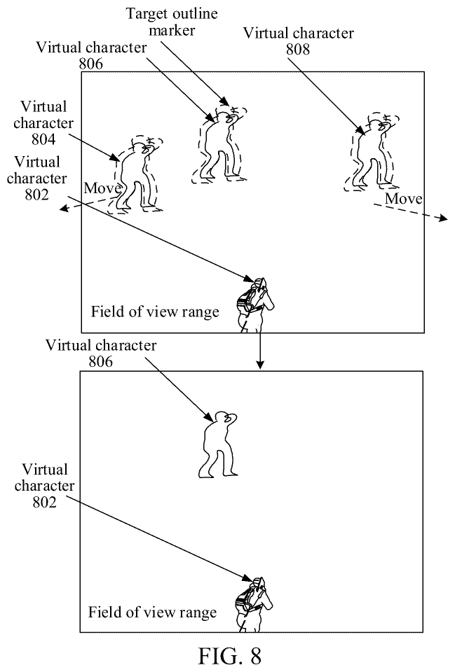

In an embodiment, FIG. 8 is a schematic diagram of still another virtual character display method according to an embodiment of the present disclosure. As shown in FIG. 8, a virtual character 802, a virtual character 804, a virtual character 806, and a virtual character 808 are included. The virtual character 802 corresponds to the foregoing first virtual character. The virtual character 804, the virtual character 806, and the virtual character 808 correspond to the foregoing second virtual characters, and jointly form the foregoing plurality of second virtual characters. After the virtual character 804, the virtual character 806, and the virtual character 808 launch attacks to the virtual character 802, the virtual character 804, the virtual character 806, and the virtual character 808 are marked in a first picture of the virtual character 802 by using target outline markers, and in this case, the virtual character 804 and the virtual character 808 move toward outside the field of view range of the foregoing virtual character 802. When the virtual character 804 and the virtual character 808 move out of the field of view range and the virtual character 806 is within the field of view range, the virtual character 806 is the foregoing target virtual character. In this case, the displaying of the foregoing target outline marker may be canceled, so that system rendering overheads and computing overheads are reduced, thereby avoiding waste of computing resources.

That the foregoing plurality of second virtual characters move outside the field of view range of the first virtual character may further include, but is not limited to, being implemented through a perspective switching behavior of the first virtual character. When the user performs the perspective switching behavior, the field of view range of the first virtual character changes. In this case, the second virtual characters within the field of view range of the first virtual character may also change, which may be that all of the second virtual characters change, some of the second virtual characters change, or all of the second virtual characters remain unchanged. In this embodiment, when some of the second virtual characters change, the displaying of the target outline marker corresponding to the target virtual character is canceled only when the target virtual character remains within the field of view range of the first virtual character.

In a solution, the displaying a target outline marker in the target application when an attack event is generated and a second virtual character is within a field of view range of the first virtual character may specifically include: displaying the target outline marker in the target application when the attack event is that the first virtual character attacks the second virtual character, the target outline marker being configured for indicating that the attack to the second virtual character is from the first virtual character.

In this embodiment, the foregoing second virtual character includes, but is not limited to, a virtual operation object that is in a different camp than the first virtual character and that is controlled by another user through a participation account in the foregoing target application; or may include, but is not limited to, a virtual operation object that is in a different camp than the first virtual character and that is preset by a system generated by the server.

In this embodiment, that the foregoing first virtual character attacks the second virtual character may include, but is not limited to, that the first virtual character launches an attack operation to the second virtual character by using a game operation such as a virtual attack prop, a virtual skill, or a virtual action. The attack operation may include, but is not limited to, reducing a virtual hit point of the second virtual character or reducing a virtual armor value of the second virtual character. In other words, when a character parameter of the second virtual character changes due to the game operation performed by the first virtual character, the foregoing first virtual character attacks the second virtual character.

In this embodiment, that the foregoing second virtual character is within the field of view range of the first virtual character may be understood as that the second virtual character may be observed in the first picture of the first virtual character, or that a location of the foregoing second virtual character in a game scene is located inside a current field of view of the first virtual character.

In this embodiment, the foregoing target outline marker is configured for indicating the second virtual character attacked by the first virtual character, that is, marking the second virtual character attacked by the first virtual character in the first picture, so that the user quickly determines the attacked virtual character through a perspective of the first virtual character, thereby preventing an attack target from being lost.

Specifically, the foregoing target outline marker may include, but is not limited to, a location marker, an outline marker, a color marker, or the like, to mark the second virtual character at the location of the second virtual character.

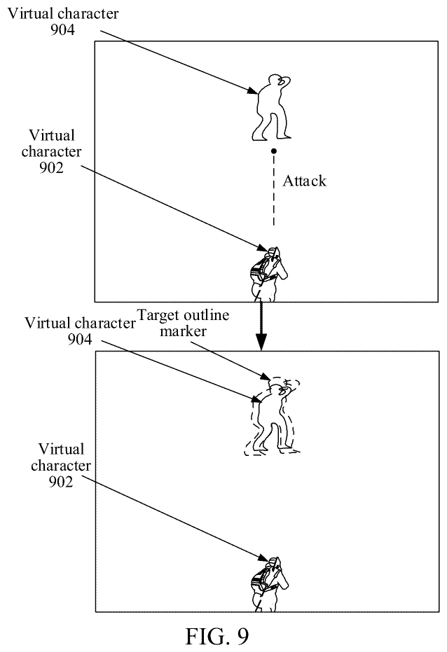

In an embodiment, FIG. 9 is a schematic diagram of still another virtual character display method according to an embodiment of the present disclosure. As shown in FIG. 9, a virtual character 902 and a virtual character 904 are included. The virtual character 902 corresponds to the foregoing first virtual character, and the virtual character 904 corresponds to the foregoing second virtual character. After the virtual character 902 launches an attack to the virtual character 904, the virtual character 904 is marked in a first picture of the virtual character 902 by using a target outline marker, so that a user controlling the virtual character 902 quickly identifies that the foregoing virtual character 904 is a virtual character attacked by the virtual character 902. The foregoing virtual character 902 and the virtual character 904 are in different camps, and the virtual character 904 is within a field of view range of the virtual character 902.

In this embodiment, the foregoing second virtual character is a virtual character allowed to move. When the second virtual character moves, the target outline marker may move following the second virtual character. Certainly, when the second virtual character does not move, the foregoing target outline marker that does not move may also be continuously displayed.

The foregoing target outline marker may be further configured as follows: The displaying of the foregoing target outline marker is canceled when the second virtual character moves, or the displaying of the foregoing target outline marker is canceled when the first virtual character moves, or the displaying of the foregoing target outline marker is canceled when the target outline marker has been displayed for preset duration.

Through this embodiment, when the first virtual character controlled by the user attacks the second virtual character, the target outline marker configured for indicating that the first virtual character attacks the second virtual character is displayed, so that when the user attacks another virtual character, the objective of quickly marking the attacked virtual character in the first picture is achieved, thereby improving efficiency of displaying the virtual character. In this way, the user can quickly learn a location of an enemy attacked by the user, thereby improving use experience.

In a solution, the displaying the target outline marker in the target application when the attack event is that the first virtual character attacks the second virtual character includes at least one of the following: displaying a second prop marker in the first picture, the second prop marker being configured for marking, in the first picture, a virtual prop used by the second virtual character when the first virtual character attacks the second virtual character; or displaying a second camp marker in the first picture, the second camp marker being configured for marking, in the first picture, a camp of the second virtual character attacked by the first virtual character.

In this embodiment, the foregoing target outline marker may include, but is not limited to, an outline marker generated according to a character model of the foregoing second virtual character. The outline marker may be configured for marking the foregoing target outline marker in the first picture in a form of a line.

In this embodiment, the foregoing second prop marker may include, but is not limited to, being configured for marking the virtual prop used by the second virtual character when the first virtual character attacks the second virtual character, marking a virtual skill used by the second virtual character when the first virtual character attacks the second virtual character, or the like, so that the attacked user can quickly determine a prop used by an enemy attacking the user, and then quickly make a counterattack solution for the enemy, thereby increasing game interest, and improving operation efficiency of the user.

In this embodiment, the foregoing second camp marker may include, but is not limited to, being configured for marking the camp of the second virtual character when the first virtual character attacks the second virtual character. Three camps or more may simultaneously participate in the game established by the foregoing target application. In this case, when the virtual character controlled by the user is attacked, the user cannot learn that an enemy in which camp attacks the virtual character; and when second virtual characters in different camps have similar appearances, it is difficult for the user to selectively counterattack a second virtual character in a specific camp. Through the foregoing camp marker, the attacked user can distinguish to perform a selective counterattack, thereby increasing game interest, and improving operation efficiency of the user.

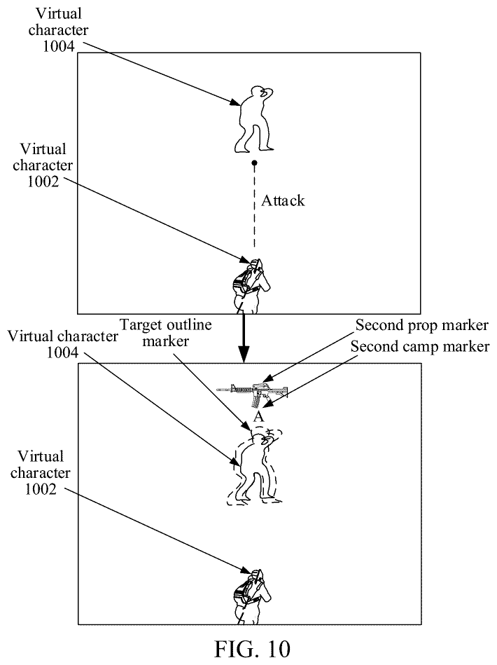

In an embodiment, FIG. 10 is a schematic diagram of still another virtual character display method according to an embodiment of the present disclosure. As shown in FIG. 10, a virtual character 1002 and a virtual character 1004 are included. The virtual character 1002 corresponds to the foregoing first virtual character, and the virtual character 1004 corresponds to the foregoing second virtual character. After the virtual character 1002 launches an attack to the virtual character 1004, the virtual character 1004 is marked in a first picture of the virtual character 1002 by using a target outline marker 10010, and then the virtual character 1004 is marked by using a second prop marker 1008 or a second camp marker 1006 according to a virtual prop used by the virtual character 1004 or a camp of the virtual character 1004, so that a user controlling the virtual character 1002 quickly learns camp information, prop information, and the like related to an enemy, thereby improving game efficiency of the user, and enriching selection of the user.

In a solution, the displaying the target outline marker in the target application when the attack event is that the first virtual character attacks the second virtual character includes at least one of the following: displaying the target outline marker in the target application according to a virtual hit point of the second virtual character attacked by the first virtual character, a color of the target outline marker being determined according to a value of the virtual hit point of the second virtual character; displaying the target outline marker in the target application according to a virtual hit point of the second virtual character attacked by the first virtual character, clarity of the target outline marker being determined according to a value of the virtual hit point of the second virtual character; or displaying the target outline marker in the target application according to a quantity of attacks by the first virtual character to the second virtual character, clarity of the target outline marker being determined according to a value of the quantity of attacks.

In this embodiment, the foregoing virtual hit point may be flexibly set according to different target applications. The virtual hit point is configured for indicating whether the foregoing second virtual character is hit and defeated. When the virtual hit point of the second virtual character is partially deducted, the foregoing second virtual character is attacked. When the virtual hit point of the second virtual character is all deducted or reaches a preset threshold, the foregoing second virtual character is defeated.

In this embodiment, the foregoing target outline marker may be configured as an outline marker with a colored edge line, for example, a red marker or a green marker. Further, the color of the foregoing target outline marker may be correlated with a current value of the virtual hit point of the foregoing second virtual character, and the depth of the foregoing color may be set to be negatively correlated with the value of the foregoing virtual hit point. In other words, a smaller virtual hit point of the second virtual character indicates a darker color of the foregoing target outline marker. In this case, when a target outline marker with a darker color is observed, the user can determine that the second virtual character is about to be defeated, and needs to defeat the second virtual character with the target outline marker as soon as possible, to improve efficiency of defeating the virtual character.

In this embodiment, the foregoing target outline marker may be configured as an outline marker filled with a pattern, for example, an outline marker filled with a preset color. The clarity of the foregoing target outline marker may be correlated with a current value of the virtual hit point of the foregoing second virtual character, and the level of the foregoing clarity may be set to be negatively correlated with the value of the foregoing virtual hit point. In other words, a smaller virtual hit point of the second virtual character indicates higher clarity of the foregoing target outline marker. In this case, when the second virtual character has a smaller virtual hit point, the user can observe a clearer target outline marker, and needs to defeat the second virtual character with the target outline marker as soon as possible, to improve efficiency of defeating the virtual character.

In this embodiment, the foregoing target outline marker may be configured as an outline marker filled with a pattern, for example, an outline marker filled with a preset color. The clarity of the foregoing target outline marker may be correlated with the foregoing quantity of attacks by the first virtual character to the second virtual character, and the level of the foregoing clarity may be set to be positively correlated with the foregoing quantity of attacks. In other words, a greater quantity of attacks indicates higher clarity of the foregoing target outline marker, to avoid that the user cannot complete a continuous attack to the second virtual character when the target outline marker is displayed due to low clarity.

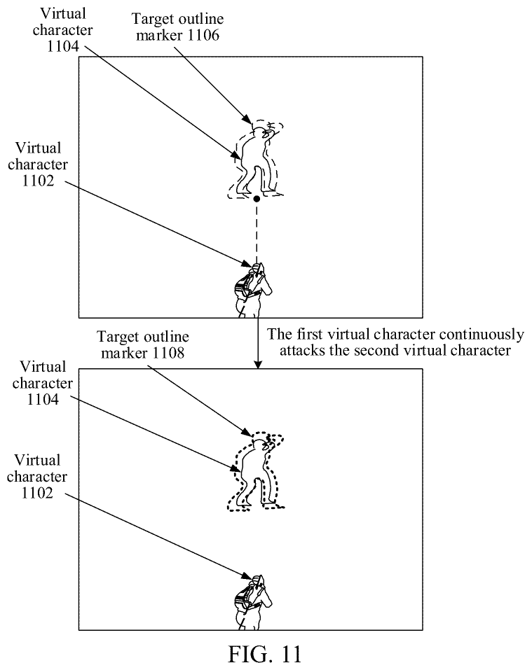

In an embodiment, FIG. 11 is a schematic diagram of still another virtual character display method according to an embodiment of the present disclosure. As shown in FIG. 11, a virtual character 1102 and a virtual character 1104 are included. The virtual character 1102 corresponds to the foregoing first virtual character, and the virtual character 1104 corresponds to the foregoing second virtual character. After the virtual character 1102 launches an attack to the virtual character 1104, the virtual character 1104 is marked in a first picture of the virtual character 1102 by using a target outline marker 1106, and in this case, a virtual hit point of the virtual character 1104 is 60. When the virtual character 1102 continuously attacks the virtual character 1104, the virtual hit point of the virtual character 1104 is deducted from 60 to 20, and the virtual character 1104 is marked in the first picture of the virtual character 1102 by using a target outline marker 1108. It can be learned from a thickness of a line in FIG. 11 that, a larger virtual hit point of the virtual character 1102 indicates a darker color and higher clarity of the target outline marker, so that the user controlling the virtual character 1102 quickly learns enemy outline information, thereby improving game efficiency of the user, and enriching selection of the user.

Through this embodiment, an outline of an attacked virtual character is displayed, to more clearly present the outline of the attacked virtual character in the first picture, so that the user can quickly learn a location of an enemy launching the attack to the user, thereby improving use experience, and improving efficiency of displaying the virtual character.

In a solution, the displaying a target outline marker in the target application when an attack event is generated and a second virtual character is within a field of view range of the first virtual character may specifically include at least one of the following:

displaying, when an attack event is generated between the first virtual character and a plurality of second virtual characters and the plurality of second virtual characters are all within the field of view range of the first virtual character, target outline markers with different colors newly added for the plurality of second virtual characters in the target application; displaying, when an attack event is generated between the first virtual character and a plurality of second virtual characters and the plurality of second virtual characters are all within the field of view range of the first virtual character, target outline markers with different flash frequencies newly added for the plurality of second virtual characters in the target application, the target outline markers being displayed in the target application in a flashing manner; or displaying, when an attack event is generated between the first virtual character and a plurality of second virtual characters and the plurality of second virtual characters are all within the field of view range of the first virtual character, target outline markers with different flow speeds newly added for the plurality of second virtual characters in the target application, the target outline markers being displayed in the target application in a flowing manner.

In this embodiment, when the plurality of second virtual characters exist, the target outline markers with different colors may be displayed for the plurality of second virtual characters, or the target outline markers with different flash frequencies may be displayed for the plurality of second virtual characters, or the target outline markers with different flow frequencies may be displayed for the plurality of second virtual characters, which may be included, but is not limited thereto.

The foregoing target outline markers may be configured to be displayed in the flashing manner according to a preset flash frequency, to prompt the user to focus on an area corresponding to the outline markers. The target outline marker may alternatively be configured as outline markers displayed in the flowing manner, to prompt the user to focus on an area corresponding to the outline markers.

In an embodiment, when the first virtual character is attacked by a second virtual character and also attacks a second virtual character, and the second virtual characters are both within the field of view range of the first virtual character, target outline markers with different colors are displayed in the target application, where a color of the target outline marker corresponding to the second virtual character attacking the first virtual character is different from a color of the second virtual character attacked by the first virtual character.

In this embodiment, the foregoing first virtual character is allowed to attack the second virtual character in a process of being attacked by the second virtual character. The foregoing first virtual character is also allowed to attack the second virtual character after being attacked by the second virtual character. The foregoing first character may also be allowed to be attacked by the foregoing second virtual character after attacking the second virtual character.

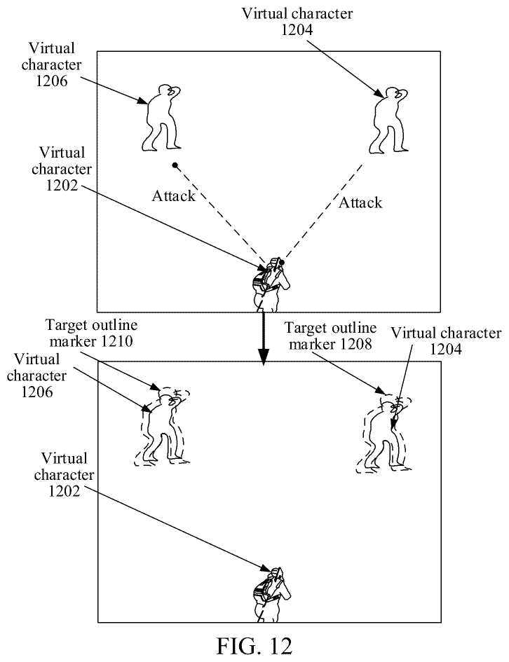

In an embodiment, FIG. 12 is a schematic diagram of still another virtual character display method according to an embodiment of the present disclosure. As shown in FIG. 12, a virtual character 1202, a virtual character 1204, and a virtual character 1206 are included. The virtual character 1202 corresponds to the foregoing first virtual character, the virtual character 1204 corresponds to the foregoing second virtual character attacking the first virtual character, and the virtual character 1206 corresponds to the foregoing second virtual character attacked by the first virtual character. After the virtual character 1202 launches an attack to the virtual character 1206, the virtual character 1206 is marked in a first picture of the virtual character 1202 by using a target outline marker 1210, so that a user controlling the virtual character 1202 quickly identifies that the foregoing virtual character 1206 is a virtual character attacked by the virtual character 1202. The foregoing virtual character 1202 and the virtual character 1206 are in different camps, and the virtual character 1206 is within a field of view range of the virtual character 1202.

After the virtual character 1204 launches an attack to the virtual character 1202, the virtual character 1204 is marked in a first picture of the virtual character 1202 by using a target outline marker 1208, so that the user controlling the virtual character 1202 quickly identifies that the foregoing virtual character 1204 is a virtual character attacking the virtual character 1202. The foregoing virtual character 1202 and the virtual character 1204 are in different camps, and the virtual character 1204 is within the field of view range of the virtual character 1202.

Through this embodiment, an outline of an attacked virtual character and an outline of a virtual character launching an attack are displayed, to clearly present the virtual characters in the first picture, thereby improving use experience, and improving efficiency of displaying the virtual characters.

In a solution, the foregoing method further includes: displaying, when the first virtual character attacks the second virtual character and the second virtual character is defeated, a target virtual object at a location at which the second virtual character is defeated, the target virtual object being configured for displaying a virtual character in a different camp than the first virtual character within a preset range of the target virtual object; displaying a target location marker in a minimap picture when the virtual character in the different camp than the first virtual character exists within the preset range of the target virtual object and the minimap picture is displayed in the first picture, the target location marker being configured for indicating, in the minimap picture, a location corresponding to the virtual character in the different camp than the first virtual character that exists within the preset range of the target virtual object; and moving, when the virtual character in the different camp than the first virtual character moves within the preset range of the target virtual object, the target location marker to the location corresponding to the virtual character in the different camp than the first virtual character within the preset range of the target virtual object.

In this embodiment, the foregoing target virtual object may include, but is not limited to, an animation, a virtual object, or the like. By using an example in which the target virtual object is an aperture animation, the aperture animation may be displayed at the location at which the second virtual character is defeated, to indicate that the virtual character in the different camp than the first virtual character that exists within a preset range of the aperture animation needs to be displayed.

When the foregoing virtual character within the preset range of the target virtual object is displayed, the target location marker may be displayed in the minimap picture, so that the user quickly learns the location of the virtual character, to perform subsequent operations.

In this embodiment, the foregoing target location marker is configured for indicating, in the minimap picture, the location corresponding to the virtual character in the camp different than the first virtual character. When the virtual character in the camp different than the first virtual character moves, the foregoing target location marker moves in the minimap picture following the virtual character.

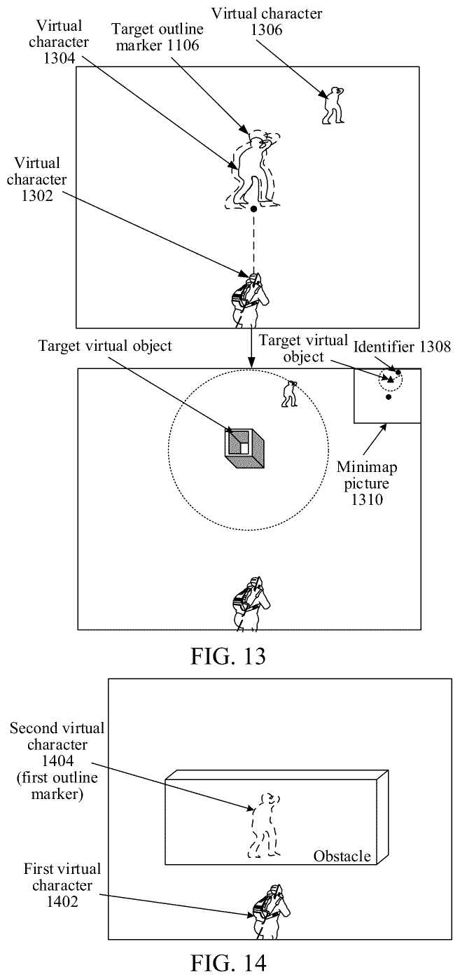

In an embodiment, FIG. 13 is a schematic diagram of still another virtual character display method according to an embodiment of the present disclosure. As shown in FIG. 13, a virtual character 1302, a virtual character 1304, and a virtual character 1306 are included. The virtual character 1302 corresponds to the foregoing first virtual character, the virtual character 1304 corresponds to the foregoing second virtual character, and the virtual character 1306 corresponds to a virtual character in a different camp than the first virtual character within the preset range of the target virtual object. After the virtual character 1302 defeats the virtual character 1304, a target virtual object is generated at a location of the virtual character 1304, and a location of the virtual character 1306 within the preset range of the target virtual object is obtained. A marker 1308 corresponding to the virtual character 1306 is displayed in a minimap picture 1310, so that a user can observe, after defeating the second virtual character, a virtual character in a different camp around when the second virtual character is defeated, to perform a subsequent attack operation.

In a solution, the foregoing method further includes: displaying a perspective outline marker corresponding to the second virtual character in the first picture when the attack event is that the first virtual character is attacked by the second virtual character, the second virtual character is within the field of view range of the first virtual character, and a virtual obstacle exists between the first virtual character and the second virtual character, the perspective outline marker being configured for performing perspective displaying on a model of the second virtual character in the first picture; and displaying the perspective outline marker corresponding to the second virtual character in the first picture when the attack event is that the first virtual character attacks the second virtual character, the second virtual character is within the field of view range of the first virtual character, and the virtual obstacle exists between the first virtual character and the second virtual character.

In this embodiment, the foregoing perspective outline marker may include, but is not limited to, an outline marker in a perspective state generated according to a perspective character model of the foregoing second virtual character. The outline marker may be configured for marking the foregoing perspective outline marker in the first picture in a form of a linc.

In an embodiment, FIG. 14 is a schematic diagram of still another virtual character display method according to an embodiment of the present disclosure. As shown in FIG. 14, a virtual character 1402 and a virtual character 1404 are included. The virtual character 1402 corresponds to the foregoing first virtual character, and the virtual character 1404 corresponds to the foregoing second virtual character. When the virtual character 1404 is located behind an obstacle, the virtual character 1404 is outside a field of view range of the virtual character 1402. In this case, a first outline marker is displayed, to display the foregoing virtual character 1404 through a perspective effect, so that a user quickly finds the virtual character 1404 hidden behind the virtual obstacle, to perform a subsequent attack operation.

Through this embodiment, when a virtual character is within a field of view range but a virtual obstacle exists between the virtual character and a virtual character controlled by a user, an outline of the virtual character may be displayed, to perform perspective displaying on a model of the virtual character in a game scene, so that the user learns a location of the marked virtual character when the marked virtual character does not appear in the first picture, and losing of a location of an enemy due to a blocked field of view is avoided, thereby improving use experience, and improving efficiency of displaying the virtual character.

In a solution, the foregoing method further includes at least one of the following: displaying a visible target outline marker of a third virtual character when the attack event is generated and the second virtual character is within the field of view range of the first virtual character, the third virtual character being a virtual character in a same camp as the first virtual character; or displaying the perspective outline marker corresponding to the second virtual character when the attack event is generated and the second virtual character is within the field of view range of the first virtual character, the perspective outline marker being configured for performing perspective displaying on the model of the second virtual character in the first picture.

In this embodiment, the third virtual character is the virtual character in the same camp as the foregoing first virtual character. That is, when the first virtual character is attacked by the second virtual character or attacks the second virtual character, the foregoing target outline marker is displayed on both the first picture of the first virtual character and a first picture of the third virtual character in the same camp as the first virtual character.

In this embodiment, the foregoing perspective outline marker may include, but is not limited to, being configured for marking the character model of the second virtual character. In addition to being configured for marking an edge of the character model of the second virtual character, the foregoing perspective outline marker may also be configured for marking an internal texture of the foregoing second virtual character. The foregoing internal texture may be divided according to different hit points deducted during an attack. For example, division is performed on a chest and arms of the virtual character through outline markers, so that the user observes locations of different portions of the second virtual character.

The foregoing perspective outline marker may be configured to be directly displayed when the attack event is generated between the first virtual character and the second virtual character. The perspective outline marker may be continuously displayed in the first picture, and even when the character model of the second virtual character is not displayed in the first picture of the first virtual character, the foregoing perspective outline marker is maintained to be displayed, to avoid a problem that, for example, it is difficult for the user to find the second virtual character because the character model of the second virtual character is not displayed in the first picture of the first virtual character after the second virtual character moves to the behind of the virtual obstacle.

This disclosure is further described below with reference to a specific example.

A user may carry a plurality of types of virtual props, which may include, but are not limited to, for example, a protection type virtual prop, an immunization type virtual prop, and an attack-assisted type virtual prop. The attack-assisted type prop may include, but is not limited to, a virtual positioning chip prop configured for marking an outline of a virtual character in an opposing camp, in other words, the foregoing virtual positioning chip prop belongs to the attack-assisted type prop. The virtual positioning chip prop may be set as a passive skill, which may take effect after the virtual positioning chip prop is equipped and a game is entered, and a corresponding function of which may be activated without any condition.

In related game applications, when a user is attacked, a direction indicator under attack may be displayed. The indicator points in a direction that an enemy launches an attack. However, the direction cannot fully indicate a current location of the enemy, and also cannot indicate which enemy attacks the user, causing difficulties for subsequent operations. Because an enemy may continuously move to change a location, if the player is equipped with the virtual positioning chip prop described in this disclosure, a game character attacking the user may be marked in a first picture.

In addition, to facilitate the user to observe a game character attacked by the user, a function of marking an outline may also be added for the game character attacked by the user.

In an embodiment, when the user participates in a game, in most cases, the user needs to attack a same game character for a plurality of times to defeat the game character. Therefore, an effect of passing through a wall to perform perspective displaying is added for a marked enemy, so that the enemy can easily found when the enemy moves to the behind of an obstacle such as a virtual wall.

In addition, after the marked game character is defeated by the user, the game character may generate an aperture in place, and locations of other enemies within a preset range of the aperture are exposed. A form of exposure may include, but is not limited to, displaying red spots on a minimap.

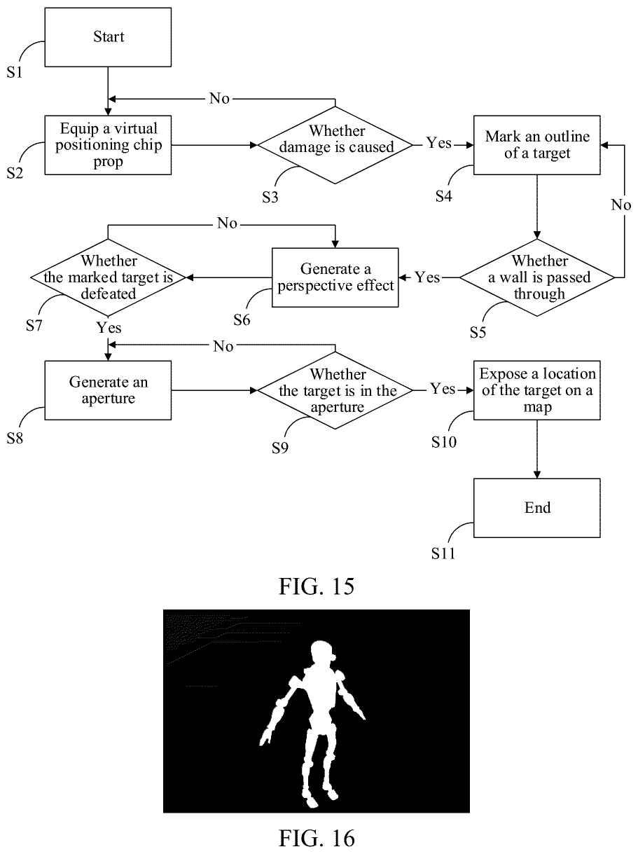

In an embodiment, FIG. 15 is a schematic diagram of still another virtual character display method according to an embodiment of the present disclosure. As shown in FIG. 15, the method may include, but is not limited to, the following procedures.

S1: Start.

S2: Equip a virtual positioning chip prop for a virtual character controlled by a user.

S3: Determine whether the virtual character controlled by the user causes damage (which corresponds to that the virtual character is attacked by the second virtual character or attacks the second virtual character described above); and return to operation S2 when a determining result is that the virtual character controlled by the user does not cause damage.

S4: Mark an outline of a target when the determining result is that the virtual character controlled by the user causes damage.

S5: Determine whether a virtual wall is passed through; and return to operation S4 when a determining result is that the virtual wall is not passed through.

S6: Generate a perspective effect when the determining result is that the virtual wall is passed through.

S7: Determine whether the marked target is defeated; and return to operation S6 when a determining result is that the marked target is not defeated.

S8: Generate an aperture when the determining result is that the marked target is defeated.

S9: Determine whether the target is in the aperture; and return to operation S8 when a determining result is that the target is not in the aperture.

S10: Expose a location of the target on a map when the determining result is that the target is in the aperture.

S11: End.

A mapping relationship between a location of a player that exists on the virtual map and a location of a minimap is first established. An implementation principle thereof may include, but is not limited to, selecting three points A, B, and C on the large map, and similarly selecting three points on the minimap as mapping points A1, B1, and C1; calculating a distance and a relative direction between each enemy and an aperture P in the large map, to determine AP, BP, and CP; and calculating A1P1, A2P2, A3P3, and taking an average value P0 from P1, P2, and P3. In this case, the value is a location to be displayed on the minimap.

In addition, in the foregoing virtual character display method, a location of a marked enemy and a current location of the user may also be obtained, to emit a ray from the location of the user for detection, where a distance detected by using the ray is a distance between the location of the marked enemy and the location of the user. If an obstacle is detected between the marked enemy and the user by using the ray, it indicates that the obstacle blocks the marked enemy and the user. In this case, a perspective effect may be generated.

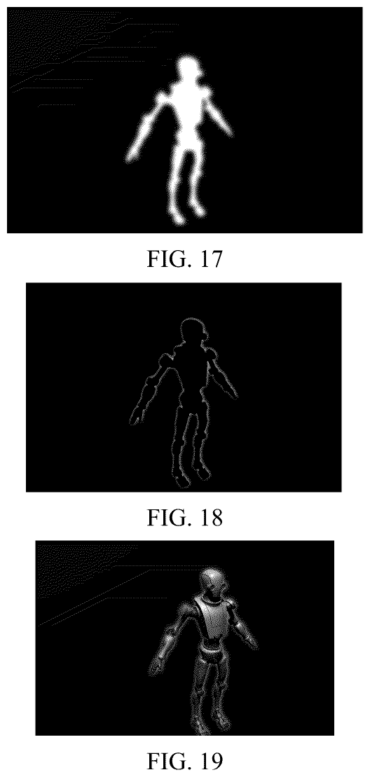

In an embodiment, a model to be stroked is added to a specific layer, a camera is copied, and a black texture is rendered. As shown in FIG. 16, an object to be stroked is subtracted into a white texture. As shown in FIG. 17, a blurring operation is performed on the texture. As shown in FIG. 18, the texture before blurring is subtracted from the blurred texture to obtain an edge texture. As shown in FIG. 19, the edge texture is superimposed with the texture rendered by the main camera.

Data related to user information and the like is involved in specific implementations of this disclosure. When the foregoing embodiments of this disclosure are applied to a specific product or technology, the user's permission or consent needs to be obtained, and collection, use, and processing of the relevant data need to comply with relevant laws, regulations, and standards of relevant countries and regions.

For brief description, the foregoing method embodiments are redisplayed as a series of action combinations. However, a person skilled in the art is to appreciate that this disclosure is not limited to the described order of the actions, because according to this disclosure, some operations may be performed in other orders or simultaneously. In addition, a person skilled in the art is also to learn that the embodiments described in this specification are all example embodiments, and the involved actions and modules are not necessarily required to this disclosure.

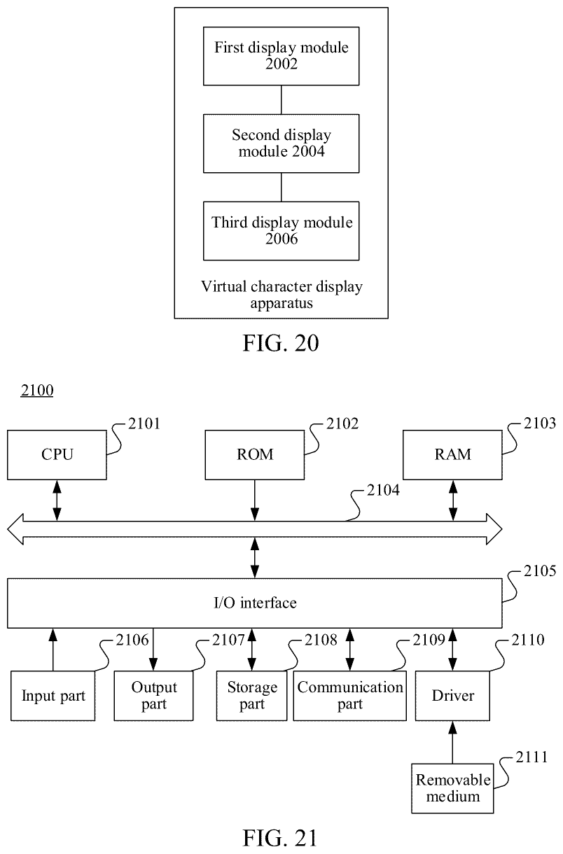

According to another aspect of the embodiments of this disclosure, an information processing apparatus, such as a virtual character display apparatus, configured to implement the foregoing virtual character display method is further provided. As shown in FIG. 20, the apparatus includes: a first display module 2002, a second display module 2004, and a third display module 2006.

The first display module 2002 is configured to display a first picture in a target application, the first picture including a first virtual character.

The second display module 2004 is configured to display a target outline marker in the target application when an attack event is generated and a second virtual character is within a field of view range of the first virtual character, the target outline marker being an outline marker newly added for the second virtual character, the target outline marker being configured for marking the second virtual character in the first picture when the attack event is generated, and the attack event including any one of that the first virtual character attacks the second virtual character, that the first virtual character is attacked by the second virtual character, or that the first virtual character attacks the second virtual character and is also attacked by the second virtual character.

The third display module 2006 is configured to move the target outline marker to a location corresponding to the second virtual character when the second virtual character moves.

In a solution, the apparatus is configured to display, in the following manner, the target outline marker in the target application when the attack event is generated and the second virtual character is within the field of view range of the first virtual character: displaying the target outline marker in the target application when the attack event is that the first virtual character is attacked by the second virtual character, the target outline marker being configured for indicating that the attack to the first virtual character is from the second virtual character.

In a solution, the apparatus is further configured to perform at least one of the following methods: displaying a first prop marker in the first picture, the first prop marker being configured for marking, in the first picture, a virtual prop used by the second virtual character when the second virtual character attacks the first virtual character; or displaying a first camp marker in the first picture, the first camp marker being configured for marking, in the first picture, a camp of the second virtual character attacking the first virtual character.

In a solution, the apparatus is configured to display, in at least one of the following manners, the target outline marker in the target application when the attack event is that the first virtual character is attacked by the second virtual character: displaying the target outline marker in the target application according to a virtual hit point of the first virtual character, a color of the target outline marker being determined according to a value of the virtual hit point of the first virtual character; displaying the target outline marker in the target application according to a virtual hit point of the first virtual character, clarity of the target outline marker being determined according to a value of the virtual hit point of the first virtual character; or displaying the target outline marker in the target application according to a quantity of attacks by the second virtual character to the first virtual character, clarity of the target outline marker being determined according to a value of the quantity of attacks.

In a solution, the apparatus is further configured to: display a plurality of target outline markers in a one-to-one correspondence with a plurality of second virtual characters in the target application when the first virtual character is attacked by the plurality of second virtual characters and the plurality of second virtual characters are all within the field of view range of the first virtual character; and cancel the displaying of the target outline marker corresponding to the target virtual character when the plurality of second virtual characters except the target virtual character move from within the field of view range of the first virtual character to outside the field of view range of the first virtual character.

In a solution, the apparatus is configured to display, in the following manner, the target outline marker in the target application when the attack event is generated and the second virtual character is within the field of view range of the first virtual character: displaying the target outline marker in the target application when the attack event is that the first virtual character attacks the second virtual character, the target outline marker being configured for indicating that the attack to the second virtual character is from the first virtual character.

In a solution, the apparatus is configured to display, in at least one of the following manners, the target outline marker in the target application: displaying a second prop marker in the first picture, the second prop marker being configured for marking, in the first picture, a virtual prop used by the second virtual character when the first virtual character attacks the second virtual character; or displaying a second camp marker in the first picture, the second camp marker being configured for marking, in the first picture, a camp of the second virtual character attacked by the first virtual character.

In a solution, the apparatus is configured to display, in at least one of the following manners, the target outline marker in the target application: displaying the target outline marker in the target application according to a virtual hit point of the second virtual character attacked by the first virtual character, a color of the target outline marker being determined according to a value of the virtual hit point of the second virtual character; displaying the target outline marker in the target application according to a virtual hit point of the second virtual character attacked by the first virtual character, clarity of the target outline marker being determined according to a value of the virtual hit point of the second virtual character; or displaying the target outline marker in the target application according to a quantity of attacks by the first virtual character to the second virtual character, clarity of the target outline marker being determined according to a value of the quantity of attacks.

In a solution, the apparatus is further configured to: display, when the first virtual character attacks the second virtual character and the second virtual character is defeated, a target virtual object at a location at which the second virtual character is defeated, the target virtual object being configured for displaying a virtual character in a different camp than the first virtual character within a preset range of the target virtual object; display a target location marker in a minimap picture when the virtual character in the different camp than the first virtual character exists within the preset range of the target virtual object and the minimap picture is displayed in the first picture, the target location marker being configured for indicating, in the minimap picture, a location corresponding to the virtual character in the different camp than the first virtual character that exists within the preset range of the target virtual object; and move, when the virtual character in the different camp than the first virtual character moves within the preset range of the target virtual object, the target location marker to the location corresponding to the virtual character in the different camp than the first virtual character within the preset range of the target virtual object.

In a solution, the apparatus is further configured to: display a perspective outline marker corresponding to the second virtual character in the first picture when the attack event is that the first virtual character is attacked by the second virtual character, the second virtual character is within the field of view range of the first virtual character, and a virtual obstacle exists between the first virtual character and the second virtual character, the perspective outline marker being configured for performing perspective displaying on a model of the second virtual character in the first picture; and display the perspective outline marker corresponding to the second virtual character in the first picture when the attack event is that the first virtual character attacks the second virtual character, the second virtual character is within the field of view range of the first virtual character, and the virtual obstacle exists between the first virtual character and the second virtual character.

In a solution, the apparatus is configured to display, in at least one of the following manners, the target outline marker in the target application when the attack event is generated and the second virtual character is within the field of view range of the first virtual character: displaying, when an attack event is generated between the first virtual character and a plurality of second virtual characters and the plurality of second virtual characters are all within the field of view range of the first virtual character, target outline markers with different colors newly added for the plurality of second virtual characters in the target application; displaying, when an attack event is generated between the first virtual character and a plurality of second virtual characters and the plurality of second virtual characters are all within the field of view range of the first virtual character, target outline markers with different flash frequencies newly added for the plurality of second virtual characters in the target application, the target outline markers being displayed in the target application in a flashing manner; or displaying, when an attack event is generated between the first virtual character and a plurality of second virtual characters and the plurality of second virtual characters are all within the field of view range of the first virtual character, target outline markers with different flow speeds newly added for the plurality of second virtual characters in the target application, the target outline markers being displayed in the target application in a flowing manner.

In a solution, the apparatus is further configured to perform at least one of the following methods:
displaying a visible target outline marker of a third virtual character when the attack event is generated and the second virtual character is within the field of view range of the first virtual character, the third virtual character being a virtual character in a same camp as the first virtual character; or
displaying the perspective outline marker corresponding to the second virtual character when the attack event is generated and the second virtual character is within the field of view range of the first virtual character, the perspective outline marker being configured for performing perspective displaying on the model of the second virtual character in the first picture.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

According to an aspect of this disclosure, a computer program product is provided, including computer programs/instructions, the computer programs/instructions including program code for performing the method shown in the flowcharts. In such an embodiment, by using a communication part 2109, the computer programs may be downloaded and installed from a network, and/or installed from a removable medium 2111. When the computer programs are executed by a central processing unit 2101, various functions provided in the embodiments of this disclosure are executed.

The sequence numbers of the foregoing embodiments of this disclosure are merely for description purpose, and are not intended to indicate priorities of the embodiments.

FIG. 21 is a schematic structural diagram of a computer system configured to implement an electronic device according to an embodiment of this disclosure.

A computer system 2100 of the electronic device shown in FIG. 21 is merely an example, and does not constitute any limitation on functions and use ranges of the embodiments of this disclosure.

As shown in FIG. 21, the computer system 2100 includes processing circuitry, such as a central processing unit (CPU) 2101, which may perform various suitable actions and processing according to a program stored in a read-only memory (ROM) 2102 or a program loaded from a storage part 2108 into a random access memory (RAM) 2103. The random access memory 2103 further stores various programs and data required for system operations. The central processing unit 2101, the read-only memory 2102, and the random access memory 2103 are connected to each other through a bus 2104. An input/output (I/O) interface 2105 is also connected to the bus 2104.

In particular, according to the embodiments of this disclosure, the processes described in method flowcharts may be implemented as computer software programs. For example, an embodiment of this disclosure includes a computer program product, including computer programs carried on a computer-readable medium, the computer programs including program code for performing the method shown in the flowcharts. In such an embodiment, by using a communication part 2109, the computer programs may be downloaded and installed from a network, and/or installed from a removable medium 2111. When the computer programs are executed by the central processing unit 2101, various functions defined in the system of this disclosure are executed.

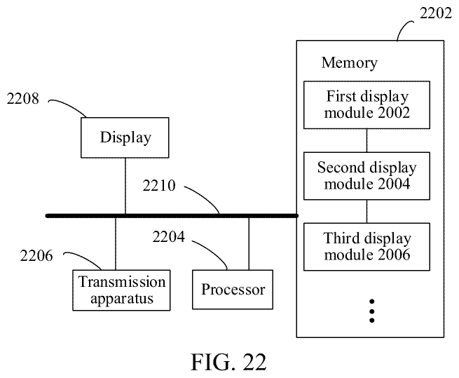

According to still another aspect of the embodiments of this disclosure, an electronic device configured to implement the foregoing virtual character display method is further provided. The electronic device may be the terminal device or the server shown in FIG. 1. In this embodiment, an example in which the electronic device is the terminal device is used for illustrative description. As shown in FIG. 22, the electronic device includes a memory 2202 and a processor 2204, the memory 2202 storing a computer program, and the processor 2204 being configured to perform operations according to any one of the foregoing method embodiments through the computer program.

In this embodiment, the foregoing electronic device may be located in at least one of a plurality of network devices in a computer network.

In this embodiment, the foregoing processor may be configured to perform the following operations through the computer program.

S1: Display a first picture in a target application, the first picture including a first virtual character.

S2: Display a target outline marker in the target application when an attack event is generated and a second virtual character is within a field of view range of the first virtual character, the target outline marker being an outline marker newly added for the second virtual character, the target outline marker being configured for marking the second virtual character in the first picture when the attack event is generated, and the attack event including any one of that the first virtual character attacks the second virtual character, that the first virtual character is attacked by the second virtual character, or that the first virtual character attacks the second virtual character and is also attacked by the second virtual character.

S3: Move the target outline marker to a location corresponding to the second virtual character when the second virtual character moves.

In one embodiment, a person of ordinary skill in the art may understand that, the structure shown in FIG. 22 is only schematic. The electronic device may be a terminal device such as a smartphone (such as an Android mobile phone or an iOS mobile phone), a tablet computer, a palmtop computer, a mobile Internet device (MID), or a PAD. FIG. 22 does not limit the structure of the foregoing electronic device. For example, the electronic device may further include more or less components (such as a network interface, and the like) than those shown in FIG. 22, or have configuration different from that shown in FIG. 22.

The memory 2202 may be configured to store a software program and a module, for example, a program instruction/module corresponding to the virtual character display method and apparatus in the embodiments of this disclosure, and the processor 2204 performs various functional applications and data processing by running a software program and a module stored in the memory 2202, that is, implementing the foregoing virtual character display method. The memory 2202 may include a high-speed random memory, and may also include a non-volatile memory, such as one or more magnetic disk storage devices, a flash memory, or another non-volatile solid-state storage device. In some examples, the memory 2202 may further include memories disposed remote to the processor 2204, and these remote memories may be connected to a terminal through a network. Examples of the network include, but are not limited to, the Internet, an intranet, a local area network, a mobile communication network and a combination thereof. The memory 2202 may be specifically, but is not limited to, storing information such as a model of a virtual character. In an example, as shown in FIG. 22, the foregoing memory 2202 may include, but is not limited to, a first display module 2002, a second display module 2004, and a third display module 2006 in the foregoing virtual character display apparatus. In addition, the memory may further include, but is not limited to, other module units in the foregoing virtual character display apparatus. The other module units are not described in detail in this example.

In addition, the foregoing electronic device further includes: a display 2208, configured to display a first picture; and a connection bus 2210, configured to connect various module components in the foregoing electronic device.

In other embodiments, the foregoing terminal device or the server may be a node in a distributed system, where the distributed system may be a blockchain system, and the blockchain system may be a distributed system formed by connecting a plurality of nodes in through network communication. The nodes may form a peer to peer (P2P) network. Any form of computing device, for example, an electronic device such as a server or a terminal, can become a node in the blockchain system by joining the P2P network.

According to an aspect of this disclosure, a computer-readable storage medium, such as a non-transitory computer-readable storage medium, is provided. A processor of a computer device reads computer instructions in the computer-readable storage medium, and the processor executes the computer instructions, to cause the computer device to perform the virtual character display method provided in the various example implementations of the foregoing aspects.

In this embodiment, the computer-readable storage medium may be configured to store a computer program configured to perform the following operations:

S1: Display a first picture in a target application, the first picture including a first virtual character.

S2: Display a target outline marker in the target application when an attack event is generated and a second virtual character is within a field of view range of the first virtual character, the target outline marker being an outline marker newly added for the second virtual character, the target outline marker being configured for marking the second virtual character in the first picture when the attack event is generated, and the attack event including any one of that the first virtual character attacks the second virtual character, that the first virtual character is attacked by the second virtual character, or that the first virtual character attacks the second virtual character and is also attacked by the second virtual character.

S3: Move the target outline marker to a location corresponding to the second virtual character when the second virtual character moves.

In this embodiment, a person of ordinary skill in the art may understand that all or a part of the operations of the methods of the foregoing embodiments may be implemented by a program instructing relevant hardware of a terminal device. The program may be stored in a computer readable storage medium. The storage medium may include a flash disk, a read-only memory (ROM), a random access memory (RAM), a magnetic disk, a compact disc, or the like.

The sequence numbers of the foregoing embodiments of this disclosure are merely for description purpose, and are not intended to indicate priorities of the embodiments.

When the integrated unit in the foregoing embodiments is implemented in the form of a software functional unit and sold or used as an independent product, the integrated unit may be stored in the foregoing computer-readable storage medium. Based on such an understanding, the technical solutions of this disclosure essentially, or the part contributing to the related art, or some or all of the technical solutions may be implemented in the form of a software product. The computer software product is stored in a storage medium, and includes several instructions for instructing one or more computer devices (which may be a personal computer, a server, a network device, and the like) to perform all or a part of the operations of the method described in the embodiments of this disclosure.

In the foregoing embodiments of this disclosure, the descriptions of the embodiments have their respective focuses. For a part that is not described in detail in an embodiment, refer to related descriptions in other embodiments.

In the several embodiments provided in this disclosure, the disclosed apparatuses and methods may be implemented in other manners. The apparatus embodiments described above are merely examples. For example, the division of the units is merely the division of logic functions, and may use other division manners during actual implementation. For example, a plurality of units or components may be combined, or may be integrated into another system, or some features may be omitted or not performed. In addition, the displayed or discussed mutual couplings or direct couplings or communication connections may be implemented through some interfaces. The indirect couplings or communication connections between the units or modules may be implemented in electronic or other forms.

The units described as separate components may or may not be physically separate, and components displayed as units may or may not be physical units, may be located in one position, or may be distributed on a plurality of network units. Some or all of the units may be selected according to an actual requirement to achieve the objectives of the solutions in the embodiments.

In addition, functional units in the embodiments of this disclosure may be integrated into one processing unit, or each of the units may be physically separated, or two or more units may be integrated into one unit. The integrated unit may be implemented in a form of hardware, or may be implemented in a form of a software functional unit.

The foregoing descriptions are merely example of implementations of this disclosure. A person of ordinary skill in the art may make several improvements or refinements without departing from the principle of this disclosure and the improvements or refinements shall fall within the protection scope of this disclosure.

What is claimed is:

1. A virtual character display method, comprising:
displaying a game scene of a first virtual character in a game application;
displaying, by processing circuitry, a target marker based on an attack event between the first virtual character and a second virtual character being generated in the game application, the target marker being configured to mark the second virtual character in the game scene when the attack event is generated; and
moving the target marker in accordance with movement of the second virtual character.

2. The virtual character display method according to claim 1, wherein
the attack event is the first virtual character being attacked by the second virtual character, and
the target marker is configured to indicate that the first virtual character is attacked by the second virtual character.

3. The virtual character display method according to claim 2, further comprising:
displaying at least one of a first prop marker or a first camp marker in the game scene, wherein
the first prop marker is configured to mark, in the game scene, a virtual prop used by the second virtual character when the second virtual character attacks the first virtual character, and
the first camp marker is configured to mark, in the game scene, a camp of the second virtual character when the second virtual character attacks the first virtual character.

4. The virtual character display method according to claim 2, wherein the displaying the target marker comprises:
displaying the target marker according to at least one of a virtual hit point of the first virtual character or a number of times the first virtual character is attacked by the second virtual character.

5. The virtual character display method according to claim 1, further comprising:
displaying a plurality of target markers in a one-to-one correspondence with a plurality of second virtual characters when the first virtual character is attacked by the plurality of second virtual characters; and
canceling the display of the target marker corresponding to one of the plurality of second virtual characters when the one of the plurality of second virtual characters moves outside a field of view of the first virtual character.

6. The virtual character display method according to claim 1, wherein
the attack event is the first virtual character being attacked by the second virtual character, and
the target marker is configured to indicate that the second virtual character is attacked by the first virtual character.

7. The virtual character display method according to claim 6, further comprising:
displaying at least one of a second prop marker or a second camp marker in the game scene, the second prop marker being configured to mark, in the game scene, a virtual prop used by the second virtual character when the first virtual character attacks the second virtual character, and the second camp marker being configured to mark, in the game scene, a camp of the second virtual character attacked by the first virtual character.

8. The virtual character display method according to claim 6, wherein the displaying the target marker comprises:
displaying the target marker according to at least one of a virtual hit point of the second virtual character attacked by the first virtual character or a number of times the second virtual character is attacked by the first virtual character.

9. The virtual character display method according to claim 1, further comprising:
displaying, when the first virtual character attacks the second virtual character and the second virtual character is defeated, a target virtual object that is configured to display a virtual character in a different camp than the first virtual character;
displaying a target location marker in a minimap when the virtual character in the different camp, the target location marker being configured to indicate, in the minimap, a location corresponding to the virtual character in the different camp; and
moving, when the virtual character in the different camp moves within a preset range of the target virtual object, the target location marker in accordance with the movement of the virtual character.

10. The virtual character display method according to claim 1, further comprising:
displaying a perspective marker corresponding to the second virtual character in the game scene when the attack event is the first virtual character being attacked by the second virtual character, and a virtual obstacle exists between the first virtual character and the second virtual character, the perspective marker being configured to display a representation of the second virtual character in the game scene; and
displaying the perspective marker corresponding to the second virtual character in the game scene when the attack event is the first virtual character attacking the second virtual character, and the virtual obstacle exists between the first virtual character and the second virtual character.

11. The virtual character display method according to claim 1, wherein the displaying the target marker comprises:
displaying, when the attack event is generated between the first virtual character and a plurality of second virtual characters, target markers with different display attributes.

12. The virtual character display method according to claim 1, further comprising:
displaying a visible target marker of a third virtual character when the attack event is generated, the third virtual character being in a same camp as the first virtual character; and
displaying a perspective marker corresponding to the second virtual character when the attack event is generated, the perspective marker being configured to display a representation of the second virtual character in the game scene when a virtual obstacle exists between the first virtual character and the second virtual character.

13. An information processing apparatus, comprising:
processing circuitry configured to:
display a game scene of a first virtual character in a game application;
display a target marker based on an attack event between the first virtual character and a second virtual character being generated in the game application, the target marker being configured to mark the second virtual character in the game scene when the attack event is generated; and
move the target marker in accordance with movement of the second virtual character.

14. The information processing apparatus according to claim 13, wherein
the attack event is the first virtual character being attacked by the second virtual character, and
the target marker is configured to indicate that the first virtual character is attacked by the second virtual character.

15. The information processing apparatus according to claim 14, wherein
the processing circuitry is configured to display at least one of a first prop marker or a first camp marker in the game scene,
the first prop marker is configured to mark, in the game scene, a virtual prop used by the second virtual character when the second virtual character attacks the first virtual character, and
the first camp marker is configured to mark, in the game scene, a camp of the second virtual character when the second virtual character attacks the first virtual character.

16. The information processing apparatus according to claim 14, wherein the processing circuitry is configured to:
display the target marker according to at least one of a virtual hit point of the first virtual character or a number of times the first virtual character is attacked by the second virtual character.

17. The information processing apparatus according to claim 13, wherein the processing circuitry is configured to:
display a plurality of target markers in a one-to-one correspondence with a plurality of second virtual characters when the first virtual character is attacked by the plurality of second virtual characters; and
cancel the display of the target marker corresponding to one of the plurality of second virtual characters when the one of the plurality of second virtual characters moves outside a field of view of the first virtual character.

18. The information processing apparatus according to claim 13, wherein
the attack event is the first virtual character being attacked by the second virtual character, and
the target marker is configured to indicate that the second virtual character is attacked by the first virtual character.

19. The information processing apparatus according to claim 18, wherein the processing circuitry is configured to:
display at least one of a second prop marker or a second camp marker in the game scene, the second prop marker being configured to mark, in the game scene, a virtual prop used by the second virtual character when the first virtual character attacks the second virtual character, and the second camp marker being configured to mark, in the game scene, a camp of the second virtual character attacked by the first virtual character.

20. A non-transitory computer-readable storage medium storing instructions which when executed by a processor cause the processor to perform:
displaying a game scene of a first virtual character in a game application;
displaying a target marker based on an attack event between the first virtual character and a second virtual character being generated in the game application, the target marker being configured to mark the second virtual character in the game scene when the attack event is generated; and
moving the target marker in accordance with movement of the second virtual character.
